(19) United States
(12) Patent Application Publication
(10) Pub. No.: US 2017/0343179 A1
(43) Pub. Date: Nov. 30, 2017

(54) LIGHTING APPARATUS

(71) Applicant: OSRAM GmbH, Munich (DE)

(72) Inventor: Igor Gurevich, Saarbruecken (DE)

(21) Appl. No.: 15/536,684

(22) PCT Filed: Nov. 4, 2015
(86) PCT No.: PCT/EP2015/075699

§ 371 Date: Jun. 16, 2017

(30) Foreign Application Priority Data
Dec. 19, 2014 (DE) 10 2014 226 646.7

(51) Int. Cl. F21S 8/10; F21V 7/04; F21K 9/64; G02B 27/30; F21V 7/06; F21Y 2115/30

(52) U.S. Cl. CPC F21S 48/1388; G02B 27/30; F21V 7/06; F21V 7/045; F21S 48/1768; F21S 48/1721; F21S 48/145; F21S 48/1225; F21S 48/1145; F21K 9/64; F21Y 2115/30

(57) ABSTRACT

A lighting apparatus is disclosed with a light generating device, at least one collimator lens, first and second parabolic mirrors, an optical diaphragm embodied in a light reflecting fashion, and a spherical mirror. The diaphragm is arranged between the parabolic mirrors, extending as far as a common focus of them. The parabolic mirror, the device and the lens are arranged so that light emitted by the device and collimated by the lens is directed onto the first parabolic mirror reflection surface and light reflected by the first parabolic mirror reflection surface impinges on the second parabolic mirror reflection surface or on the diaphragm. The spherical mirror is arranged so that its focus is arranged at the common focus of the parabolic mirrors and light reflected at the diaphragm impinges on the spherical mirror reflection surface and is directed from the reflection surface onto the second parabolic mirror reflection surface.

### RELATED APPLICATIONS

The present application is a national stage entry according to 35 U.S.C. §371 of PCT application No.: PCT/EP2015/075699 filed on Nov. 4, 2015, which claims priority from German application No.: 10 2014 226 646.7 filed on Dec. 19, 2014, and is incorporated herein by reference in its entirety.

### TECHNICAL FIELD

The present disclosure relates to a lighting apparatus in accordance with the preamble of claim 1.

### BACKGROUND

A lighting apparatus of this type is described for example in the published patent application DE 102013207845 A1. That document describes a lighting apparatus including a plurality of light sources, the light from which is collected by means of a primary optical unit and converted into an intermediate light distribution, which is optically processed further by means of a secondary optical unit.

### SUMMARY

It is an object of the present disclosure to provide a lighting apparatus of the generic type which makes it possible to generate a standard-conforming light distribution in front of the motor vehicle and in particular makes it possible to form a bright-dark boundary, for example for a low-beam light.

This object is achieved according to the present disclosure by means of a lighting apparatus having the features from claim 1. Particularly advantageous embodiments of the present disclosure are described in the dependent claims.

The lighting apparatus according to the present disclosure has a light generating device and at least one collimator lens, advantageously embodied in an aspherical fashion, which serves for collimating the light emitted by the light generating device. Moreover, the lighting apparatus according to the present disclosure has a first parabolic mirror, which is advantageously shaped as a paraboloid of revolution, a diaphragm embodied in a light reflecting fashion, and a second parabolic mirror, which is advantageously shaped as a paraboloid of revolution, wherein the diaphragm is arranged between the two parabolic mirrors and extends as far as a common focus of the two parabolic mirrors, and wherein the parabolic mirror and the light generating device and also the at least one collimator lens are arranged in such a way that light which is emitted by the light generating device and collimated by the at least one collimator lens is directed onto the reflection surface of the first parabolic mirror and light reflected by the reflection surface of the first parabolic mirror impinges on the reflection surface of the second parabolic mirror or on the diaphragm.

On account of its features mentioned above, the lighting apparatus according to the present disclosure enables a sharp imaging of its light source into the far field of the lighting apparatus. With the aid of the diaphragm, part of the light which is emitted by the light generating device and reflected at the reflection surface of the first parabolic mirror is masked out and, as a result, a sharp bright-dark boundary is generated which is projected into the far field of the lighting apparatus by means of the parabolic mirrors. As a result, a sharp image of the bright-dark boundary arises in the far field. The light distribution in the far field can be influenced by the shape of the light source and the shape of the diaphragm.

In addition, the lighting apparatus according to the present disclosure includes a spherical mirror, which is arranged in such a way that its focus is arranged at the common focus of the two parabolic mirrors and light reflected at the diaphragm is directed onto the reflection surface of the second parabolic mirror.

By virtue of the abovementioned additional features of the lighting apparatus according to the present disclosure, the available light intensity is increased because the light which is emitted by the light generating device and which is masked out by means of the diaphragm for the purpose of generating a bright-dark boundary is directed onto the second parabolic mirror with the aid of the spherical mirror and is thus likewise supplied to the light distribution in the area in front of the lighting apparatus or in front of the motor vehicle. The spherical mirror generates at the common focus an image of the light emitting surface of the light generating device that is shaded by the diaphragm, which image is superimposed, at the common focus, on the image of the light emitting surface of the light generating device that is generated by the first parabolic mirror and that is not shaded by the diaphragm. Since the image generated by the spherical mirror is merely angle-rotated relative to the image generated by the first parabolic mirror, the bright-dark boundary generated by the diaphragm is maintained and the light intensities of both images are added together. By means of the second parabolic mirror, the superimposed images are projected into the far field of the lighting apparatus or into the area in front of the motor vehicle.

Advantageously, the spherical mirror of the lighting apparatus according to the present disclosure is arranged and embodied in such a way that it generates an image of a light distribution with a magnification factor having the absolute value 1 at the common focus. This ensures that the image generated by the spherical mirror has the same size and shape as the image generated by the first parabolic mirror and the two images can be superimposed substantially congruently at the common focus.

The spherical mirror of the lighting apparatus according to the present disclosure is advantageously embodied integrally with the first parabolic mirror. As a result, it is possible to dispense with an additional mount for the spherical mirror.

Advantageously, the spherical mirror of the lighting apparatus according to the present disclosure is embodied in a movable fashion, in order to make it possible to adjust the spherical mirror relative to the diaphragm and the first parabolic mirror.

The light source used is advantageously a light emitting surface of the light generating device of the lighting apparatus according to the present disclosure, the light from which is collimated by means of the collimator lens advantageously embodied in an aspherical fashion.

Advantageously, the light generating device of the lighting apparatus according to the present disclosure includes at least one semiconductor light source, which is particularly advantageously embodied as a laser diode, and a light wavelength conversion element for the wavelength conversion of the light emitted by the at least one semiconductor light source, in order to generate white light that is a mixture of non-converted primary light and secondary light converted by the light wavelength conversion element. Laser diodes that emit blue light and a light wavelength conversion element on the basis of cerium-doped yttrium aluminum garnet (YAG:Ce) are advantageously used in order to convert blue primary light of the laser diodes proportionally into yellow secondary light. As a result, the surface of the light wavelength conversion element emits white light that is a mixture of blue primary light and yellow secondary light. The light emitting surface of the light wavelength conversion element can therefore itself be regarded as a light source. By virtue of the shaping of the light emitting surface of the light wavelength conversion element and the shaping of the diaphragm, it is therefore possible to influence the light distribution in the far field of the lighting apparatus according to the present disclosure. A suitable light generating device, including five laser diodes and a light wavelength conversion element, for the lighting apparatus according to the present disclosure is disclosed for example in the German patent application having the application number 10 2014 220 276.0. The collimator lens, advantageously embodied in an aspherical fashion, of the lighting apparatus according to the present disclosure is advantageously arranged at a distance of a few millimeters from the light emitting surface of the light wavelength conversion element. It corresponds for example to the lens bearing the reference sign that is disclosed in FIG. 2 of the German patent application having the official application number 10 2014 220 276.0, said lens being arranged at a small distance from the light emitting surface of the light wavelength conversion element.

The diaphragm of the lighting apparatus according to the present disclosure is advantageously embodied in a movable fashion. As a result, it is possible to vary the degree of shading or masking-out of the light which is emitted by the light generating device and is reflected at the first parabolic mirror. By way of example, in the case of a defective light generating device, in particular in the case of a defective or absent light wavelength conversion element, by means of the diaphragm a complete shading of the light emitted by the light generating device can be carried out by virtue of the diaphragm in the region of the common focus of the two parabolic mirrors being shifted completely into the beam path of the reflected light at the reflection surface of the first parabolic mirror.

That surface of the advantageously metallically embodied diaphragm which faces the spherical mirror is advantageously embodied as a specularly reflective surface, for example by polishing of the surface and/or by suitable surface reflective coating, for example with a gold or silver coating. Alternatively or additionally, that surface of the diaphragm which faces the spherical mirror can also contain diffusely reflective regions and/or light absorbing regions or can be embodied entirely in a diffusely mirroring fashion. That surface of the diaphragm which faces the spherical mirror is advantageously embodied in a planar fashion, but can also have elevations and/or depressions of the material, for example convex, concave and/or freeform-embodied surface regions. Said elevations and/or depressions of the material of the diaphragm make it possible to modulate the radiation (useful light) reflected at the diaphragm. The two parabolic mirrors of the lighting apparatus according to the present disclosure advantageously include concave reflection surfaces. Advantageously, the reflection surfaces of the parabolic mirrors face one another and are arranged at a distance amounting to the sum of their focal lengths and are aligned in such a way that light which is emitted by the light generating device and is collimated by the at least one collimator lens is deflected twice by means of the concave reflection surfaces of the two parabolic mirrors, wherein, by means of the diaphragm extending as far as the common focus of the two parabolic mirrors, part of the light is masked out, which is directed to the spherical mirror and is reflected via the latter onto the second parabolic mirror. In accordance with the preferred embodiment of the present disclosure, the parabolic mirrors are aligned in such a way that light which is reflected at the reflection surface of the second parabolic mirror passes in a manner offset substantially parallel with respect to the light emerging from the light generating device and the collimator lens.

The lighting apparatus according to the present disclosure is advantageously embodied as a vehicle headlight or as part of a vehicle headlight.

### BRIEF DESCRIPTION OF THE DRAWING(S)

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a plan view of the lighting apparatus in accordance with one preferred embodiment of the present disclosure in a schematic illustration.

### DETAILED DESCRIPTION

The lighting apparatus in accordance with the preferred embodiment of the present disclosure is part of a motor vehicle headlight and has a light generating device 1, an aspherical collimator lens 2, a first parabolic mirror 3 having a concave reflection surface 30 shaped as a paraboloid of revolution, and an optical diaphragm 5 embodied in a light reflecting fashion, and also a second parabolic mirror 4 having a concave reflection surface 40 shaped as a paraboloid of revolution, and a spherical mirror 6 having a concave, spherical reflection surface 60.

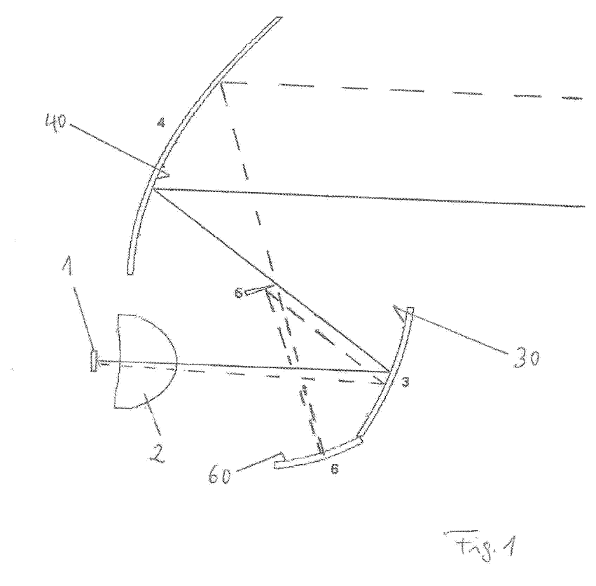

The light generating device 1 consists of a plurality of laser diodes which emit blue light during operation, and a light wavelength conversion element, onto which the light emitted by the laser diodes is directed. The light wavelength conversion element includes a yellow phosphor (YAG:Ce) that converts the blue light (also called primary light) emitted by the laser diodes proportionally into yellow light (also called secondary light), such that white light that is a mixture of blue primary light and yellow secondary light is emitted from the surface of the light wavelength conversion element. The light emitting surface of the light wavelength conversion element is advantageously embodied in a circular-disk-shaped fashion. In FIG. 1, the reference sign 1 denotes the light generating device or the light emitting surface of the light wavelength conversion element of the light generating device.

The collimator lens 2 is arranged at a distance of 1 to 5 mm, for example, from the light emitting surface of the light wavelength conversion element of the light generating device 1. The collimator lens 2 reduces the divergence of the white light emitted by the light emitting surface of the light wavelength conversion element of the light generating device 1 and directs it onto the concave reflection surface 30 of the first parabolic mirror 3.

At the concave reflection surface 40 of the second parabolic mirror 4, the light is directed back in its original direction. The distance between the parabolic mirrors 3, 4 corresponds to the sum of the focal lengths of both parabolic mirrors 3, 4. The optical diaphragm 5 embodied in a light reflecting fashion is arranged between the two parabolic mirrors 3, 4 and extends as far as the common focus of the parabolic mirrors 3, 4.

The spherical mirror 6 is arranged directly alongside the first parabolic mirror 3 in such a way that its focus coincides with the common focus of the two parabolic mirrors 3, 4 and light which is reflected at the optical diaphragm 5 is directed onto the concave, spherical reflection surface 60 of the spherical mirror 6 and is directed from said reflection surface to the concave reflection surface 40 of the second parabolic mirror 4.

The aspherical collimator lens 2 and the first parabolic mirror 3 generate an image of the circular-disk-shaped light emitting surface of the light generating device 1 in the region of the common focus of the two parabolic mirrors 3, 4. Said image is likewise circular-disk-shaped. The diameter D2 of said image is calculated from the diameter D1 of the circular-disk-shaped light emitting surface of the light generating device 1, the focal length F1 of the collimator lens 2 and the focal length F2 of the first parabolic mirror 3 as D2=D1×F2/F1.

By means of the optical diaphragm 5 extending right into the common focus, part of the light emitted by the circular-disk-shaped light emitting surface of the light generating device 1 is masked out and directed onto the reflection surface 60 of the spherical mirror 6. By way of example, the diaphragm 5 is arranged in such a way that half of the light emitted by the circular-disk-shaped light emitting surface of the light generating device 1 and thus half of the abovementioned circular-disk-shaped image is masked out. This image therefore assumes the shape of half a circular disk and is referred to hereinafter as first image. That part of the light emitted by the circular-disk-shaped light emitting surface of the light generating device 1 which is not reflected by the diaphragm 5 is directed from the reflection surface 30 of the first parabolic mirror 3 directly to the reflection surface 40 of the second parabolic mirror 4.

The light which is directed from the diaphragm 5 onto the spherical mirror 6 and is reflected at the reflection surface 60 of the spherical mirror 6 generates at the common focus of the parabolic mirrors 3, 4 and of the spherical mirror 6 a second image of the circular-disk-shaped light emitting surface of the light generating device 1, which image likewise has the shape of half a circular disk and has the same size and alignment as the first image. The first image is superimposed with the second image at the common focus of the parabolic mirrors 3, 4 and projected by means of the second parabolic mirror 4 into the far field of the lighting apparatus or into the area in front of a motor vehicle headlight. In this case, the light intensities of both images are added together, thereby virtually doubling the light intensity of the light distribution in the abovementioned far field or area in front.

FIG. 1 illustrates schematically by way of example by means of solid lines the light beam path for a light beam which passes through the optical arrangement of the two parabolic mirrors 3, 4 without reflection at the diaphragm 5 and at the spherical mirror 6 and serves for generating the first image at the common focus. Moreover, FIG. 1 illustrates schematically by way of example by means of dashed lines the light beam path for a light beam which passes through the optical arrangement of the two parabolic mirrors 3, 4 after reflection at the diaphragm 5 and at the spherical mirror 6 and serves for generating the second image at the common focus.

The lighting apparatus is configured, as a light module of a motor vehicle headlight by itself or in interaction with other light modules of said headlight or of a different headlight, to generate a standard-conforming light distribution in the area in front of the motor vehicle, in particular a bright-dark boundary, for example the bright-dark boundary of a low-beam light.

To that end, the light which is emitted by the light wavelength conversion element of the light generating device 1 and which consists proportionally of non-converted blue primary light emitted by the laser diodes and directed onto the light wavelength conversion element, and of secondary light generated by the yellow phosphor of the light wavelength conversion element, is collimated by a, advantageously aspherical, converging lens or collimator lens disposed downstream of the light wavelength conversion element, in the case of which lens both the entrance side and the exit side are embodied in an aspherical fashion.

In this case, the collimator lens 2, which is embodied as an asphere or as an achromat, collimates the light from the light generating device 1 and directs it onto the concave reflection surface 30 of the first parabolic mirror 3, which then generates an image of the light emitting surface of the light generating device 1 or of the light wavelength conversion element of the light generating device 1 in an intermediate image plane. The intermediate image plane is situated at the common focus of the two parabolic mirrors 3, 4. The concave reflection surface 40 of the second parabolic mirror 4 then sharply images the intermediate image thus generated into the far field or into infinity. The cross section of the intermediate image or of the image of the light wavelength conversion element is embodied in a circular fashion in the case of a circular-disk-shaped light wavelength conversion element.

The light from the light wavelength conversion element of the light generating device 1 is thus light composed of portions of non-converted primary light of the blue-emitting laser diodes and the secondary light of the yellow phosphor, that is to say produces white, or multichromatic, light.

The light wavelength conversion element advantageously has a circular-disk-shaped emission surface or is itself embodied as a circular-disk-shaped light wavelength conversion element. Alternatively, the light wavelength conversion element can also have a polygonal contour, in particular a rectangular or square contour. The light emitting surface of the light wavelength conversion element facing the collimator lens 2 can also be provided with a cover, such that only a desired surface region, for example a circular-disk-shaped segment, contributes to the emission of light.

The surface of the light wavelength conversion element is advantageously configured in a planar fashion.

The diaphragm 5 is fitted in the abovementioned intermediate image plane, said diaphragm reflecting part of the beam path. In this case, the diaphragm 5 is positioned such that a region of the light beam path is covered in such a way that a correctly positioned bright-dark boundary forms in the far field. In this case, the edge of the diaphragm 5 is advantageously shaped rectilinearly. Alternatively, insofar as a non-straight bright-dark boundary is desired, a freeform edge shape of the diaphragm can be chosen.

In this case, the thickness of the diaphragm is chosen such that no disturbing cast shadows are formed. In this regard, the diaphragm thickness at the shading region can be from a few tenths of a millimeter to a few millimeters; alternatively, the diaphragm edge of the shading region can also taper in the shape of a knife edge and form a pointed edge. The diaphragm 5 can be embodied in a solid fashion, for example made from a metal having good thermal conductivity.

By means of the spherical mirror 6, that part of the light emitted by the light generating device 1 which is masked out by the diaphragm 5 is recycled and likewise used for generating the desired light distribution in the far field of the lighting apparatus or in the area in front of a motor vehicle headlight.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lighting apparatus comprising
a light generating device and
at least one collimator lens which serves for collimating the light emitted by the light generating device,
further comprising,
a first parabolic mirror,
an optical diaphragm embodied in a light reflecting fashion,
a second parabolic mirror, wherein the diaphragm is arranged between the two parabolic mirrors and extends as far as a common focus of the two parabolic mirrors, and wherein the parabolic mirror and the light generating device and the at least one collimator lens are arranged in such a way that light which is emitted by the light generating device and collimated by the at least one collimator lens is directed onto the reflection surface of the first parabolic mirror and light reflected by the reflection surface of the first parabolic mirror impinges on the reflection surface of the second parabolic mirror or on the diaphragm, and
a spherical mirror, which is arranged in such a way that its focus is arranged at the common focus of the parabolic mirrors and light reflected at the diaphragm impinges on the reflection surface of the spherical mirror and is directed from the reflection surface onto the reflection surface of the second parabolic mirror.

2. The lighting apparatus as claimed in claim 1, wherein the spherical mirror is arranged and embodied in such a way that it generates an image of a light distribution with a magnification factor having the absolute value 1 at the common focus.

3. The lighting apparatus as claimed in claim 1, wherein the spherical mirror is embodied integrally with the first parabolic mirror.

4. The lighting apparatus as claimed in claim 1, wherein the spherical mirror is movable.

5. The lighting apparatus as claimed in claim 1, wherein the optical diaphragm is movable.

6. The lighting apparatus as claimed in claim 1, wherein the light generating device comprises at least one semiconductor light source and a light wavelength conversion element.

7. The lighting apparatus as claimed in claim 6, wherein the at least one semiconductor light source is embodied as a laser diode.

8. The lighting apparatus as claimed in claim 1, wherein the lighting apparatus is embodied as a vehicle headlight or as part of a vehicle headlight.

9. The lighting apparatus as claimed in claim 1, wherein the at least one collimator lens is embodied in an aspherical fashion.
